(19) United States
(12) Patent Application Publication
(10) Pub. No.: US 2004/0180118 A1
(43) Pub. Date: Sep. 16, 2004

(54) Reclosable pack

(76) Inventors: Thomas Renger, Monheim (DE); Thomas Offergeld, Duesseldorf (DE); Dirk Vianden, Ulm (DE); Juergen Fett-Schudnagis, Duesseldorf (DE)

Correspondence Address: HENKEL CORPORATION, THE TRIAD, SUITE 200, 2200 RENAISSANCE BLVD., GULPH MILLS, PA, 19406, US

(21) Appl. No.: 10/771,648

(22) Filed: Feb. 4, 2004

Related U.S. Application Data
(63) Continuation of application No. PCT/EP02/08687, filed on Aug. 3, 2002.

(30) Foreign Application Priority Data
Aug. 6, 2001 (DE) 101 37 808.4

(51) Int. Cl. C12C 1/027

(52) U.S. Cl. 426/106

(57) ABSTRACT

A resealable container is provided having a container opening and a rim and a multilayer film covering the container opening and the rim. The multilayer film contains at least an outer layer, a sealing layer facing the rim and a layer of adhesive between the outer layer and the sealing layer. The sealing layer is secured around the rim and contains a weak spot such that when the resealable container is first opened a double bead of said sealing layer remains on the rim in the region of the weak spot. Such resealable containers have improved tear-open behavior and resealability.

This application is a continuation under 35 USC Sections 365(c) and 120 of International Application No. PCT/EP02/08687, filed 3 Aug. 2002 and published 20 Feb. 2003 as WO 03/013976, which claims priority from German Application No. 10137808.4, filed 6 Aug. 2001, each of which is incorporated herein by reference in its entirety.

### FIELD OF THE INVENTION

This invention relates to a resealable container (7) comprising a rim (8) and a multilayer film (9) covering the container opening (10) and the rim (8), the multilayer film (9) consisting at least of an outer layer (1), a sealing layer (2) facing the rim (8) and a layer (3) of adhesive between the outer layer (1) and the sealing layer (2) and the sealing layer (2) being secured around the rim (8) and being embrittled to form a weak spot (11), and to a process for the production of a resealable container. The present invention also relates to a sealing tool (12) for making the resealable container (7).

### DISCUSSION OF THE RELATED ART

Articles of everyday use, for example foods, animal foods, and also disposable articles, for example disposable tableware or paper handkerchiefs, are often marketed in portioned form to make them easier for the consumer to handle and to facilitate portioning. Examples of portioned foods are sausage, cheese and ready-to-eat salads or even snacks, such as savoury sticks for example, which are already portioned in the pack. The consumer merely has to open the pack, remove the desired amount of food and then store the rest pending complete consumption. However, a problem is that packs of the type in question often cannot be resealed. As a result, the food remaining in the pack dries out during storage, becomes unsightly and loses its typical taste. Although there are packs where the cover can be replaced by mechanical engagement in an encircling bead, such packs are attended by the disadvantage that they are generally bulky and are unable to meet commercial demands for space-saving packs. There are also packs where the cover is attached to the container by an adhesive. Unfortunately, packs such as these often have the disadvantage that, even after being opened just once, they cannot be reclosed through lack of contact adhesive properties.

Mechanically reclosable packs are described, for example, in DE 3935480 A1. DE 3935480 A1 discloses a pack in which a plastic cover is attached to a bowl-like plastic lower part via a first weld seam. In order to form a tear strip, a weakening line and/or a second weld seam is/are provided around the entire upper rim of the lower part at a distance (a) from the first weld seam to the middle of the cover. To open the pack, the tear strip is pulled clockwise to a weld, the seal (weld seam) remaining permanent, i.e., is not itself torn open. The pack is easy to open without being of the cover. A hinge is formed via a weld and enables the cover to be opened and then reclosed after complete or partial emptying of the pack.

There are also resealable packs where a layer of pressure-sensitive adhesive is exposed when the container is opened for the first time and, for reclosing, is pressed onto the rim of the container. U.S. Pat. No. 4,913,307 discloses a pack in which a multilayer cover comprising an inner layer and a substrate layer is heat-sealed against the rim of the container in a region of width “b”. The edges of the heat sealing tool are “pointed” so that, when the cover is sealed/pressed against the rim of the container, the sealing zone in “b” is defined by circular inner and outer depressions which are said to provide for more precise tearing of the multilayer film. The substrate layer is designed to be peeled off the inner layer and, for resealing, can be replaced and sealed.

EP 0 868 368 B1 describes a closure (S) for a container (C) with an opening (O) which comprises a leaf (F) welded on along the rim of the container opening, the leaf (F) consisting of at least three layers, namely: a weld layer (1) which is applied to the rim of the opening and welded thereto along a bead (4) of width (L); an outer layer (2) which forms a barrier; and an adhesive layer (3) between layers (1) and (2), the weld layer being weakened in the region of the bead (4). The weakening of the weld layer in the region of the bead (4) is achieved by welding the bead (4) by means of a heating rod (6) so that the weld layer (1) and the adhesive layer (3) are deformed over the entire width (L) of the bead (4). The adhesive layer (3) is formed by application of a resin with a minimum thickness of 10 micrometers.

The reclosable/resealable containers known from the prior art have the disadvantage that resealing is often not sufficiently guaranteed. In transit and particularly if the pack is inverted in transit, the cover of the reclosed pack can come off unintentionally so that the contents of the pack can fall out. This can be caused by often unsatisfactory tear-open behavior of the weld films for exposing the adhesive. Thus, the initial tearing of the weld film requires increased application of force which results in deformation of the cover so that an accurate fit is not longer guaranteed.

Accordingly, one of the problems addressed by the present invention was to improve both tear-open behavior and safe reclosing/resealing for reclosable/resealable packs.

Another problem addressed by the present invention was to improve resealability, particularly in the presence of moisture and at low temperatures, more particularly at refrigerator or freezer temperatures. If the containers are removed, for example from a refrigerator, and opened, condensed water can form a thin film of moisture on the rim of the container and on the exposed adhesive film so that the pack can only be resealed with difficulty, if at all. In addition, it can happen during storage under deep-freeze conditions that the adhesive layer only has reduced adhesion and no longer adheres sufficiently so that the closure opens.

Accordingly, another problem addressed by the present invention was to improve the adhesion of the adhesive layer for the safe resealing of resealable containers, more particularly in the presence of moisture and at temperatures in the range from 5° C. to −20° C.

In addition, consumers often complain about the smell of the empty space of the closed pack which is attributable to constituents of the adhesive or the film.

Accordingly, another problem addressed by the present invention was to provide a substantially odorless adhesive layer for resealable containers.

There is also a demand for adhesive layers which do not become stringy when the multilayer film is torn open or when the adhesive-layer is exposed for the first time or during subsequent resealing and opening of the container. In continuous packaging machines, it is often found that the cutting tools become soiled with adhesive. Accordingly, another problem addressed by the present invention was to provide an adhesive for the adhesive layer which would show reduced cold flow.

In the production of known resealable containers, the uppermost layer of the multilayer film is occasionally deformed during the sealing process. Because of this, there is also a need for improved sealing tools for the production of resealable containers. In addition, the packaging industry and consumers alike would like the tendency the film has to curl after lamination and after tearing open to be minimized.

### BRIEF SUMMARY OF THE INVENTION

The problems stated above have been solved by a resealable container (7) comprising a rim (8) and a multilayer film (9) covering the container opening (10) and the rim (8), the multilayer film (9) comprising at least an outer layer (1), a sealing layer (2) facing the rim (8) and a layer (3) of adhesive between the outer layer (1) and the sealing layer (2) and the sealing layer (2) being secured around the rim (8) and being embrittled to form a weak spot (11). In the region of the weak spot (11), the sealing layer (2) produces a resistance to removal which is greater than the adhesive force between the sealing layer (2) and the adhesive layer (3) so that, during the very first opening step, the sealing layer (2) remains in the region of the weak spot (11) and separates in a process in which the rest of the sealing layer (2) is torn off and a corresponding region (4) of the adhesive layer is exposed, so that the container (7) can be resealed by applying the exposed region (4) of the adhesive layer (3) to the weak spot (11) of the remaining sealing layer. Embrittlement is achieved with a sealing tool (12) so that the weak spot (11) is in the form of a double bead over the width (13).

### BRIEF DESCRIPTION OF THE FIGURES

FIG. 1 schematically illustrates the composition of the multilayer film (9).

FIG. 2 is a schematic cross-section through the resealable container (7) according to the invention in its closed state.

FIG. 3 is a schematic cross-section through the resealable container (7) after sealing in a partly opened state.

FIGS. 4-6 are schematic cross-sections of different embodiments of the sealing tool (12) according to the invention.

FIG. 7 is a schematic plan view of the sealing zone with a schematized partial region in which one or all the sealing edges is/are weakened.

FIG. 8 is a schematic plan view of a seal that is angular in the vicinity of the tear strip.

### DETAILED DESCRIPTION OF CERTAIN EMBODIMENTS OF THE INVENTION

“Sealing” is generally understood to be the process whereby a soft sealing medium sets adhesively. Heat and/or a minimum sealing pressure are required for this purpose. Accordingly, there is a difference between heat sealing and cold sealing, the question of which method of sealing to apply being dependent upon the materials used, the product to be packaged (for example its sensitivity to heat) and the type of packaging machine.

The process of cold sealing uses cold sealing adhesives (“cold sealing compounds”) which bond two polymer layers at around room temperature under high pressure. Cold sealing adhesives are mostly applied to the polymer to be bonded as aqueous dispersions in a quantity of 1 to 6 g/m² and are based on rubber and rubber-like polymers, PVDC (polyvinylidene chloride), PVAC (polyvinyl acetate) and poly(meth)acrylates. The process of heat sealing uses heat sealing dispersions, heat sealing lacquers, hotmelt adhesives and films of thermoplastic elastomers and extrusion coatings. Heat sealing dispersions are predominantly PVDC-, PVAC-, poly(meth)acrylate- or latex-containing dispersions which, after evaporation of the water, form sealable, dry and generally transparent coatings when applied in quantities of 2 to 15 g/m². In contrast to heat sealing dispersions, organic solvents are employed in heat sealing lacquers using the same or similar polymers. Heat sealing lacquers are applied in quantities of ca. 1 to 1.2 g/m². Generally, heat sealing lacquers cannot be used for sealing against materials of different kinds.

Heat sealing adhesives based on hotmelt adhesives are generally based on ethylene/vinyl acetate copolymers which are applied to the substrate by roller or even by extrusion.

Films of thermoplastic elastomers and extrusion coatings are also used for heat sealing. Such films are often referred to as “welding” films and are used for “welding” as opposed to “sealing”. In a particularly preferred embodiment of the present invention, these films are used as the “sealing layer (2)”. Co-extrudates also belong to this group, co-extrudates being multilayer films of which the layers are “meltingly” extruded together in a single process known as extrusion. Any polymers, preferably elastomers, which are thermoplastic at temperatures of ca. 50 to ca. 220° C. are sealable or weldable. Above all, the extrusion coating of PE (polyethylene) onto carrier foils/films, such as aluminium, polypropylene, polyester and polyamide, allows a number of packaging material specifications.

A preferred embodiment of the invention is described in the following with reference to the accompanying drawings, wherein:

FIG. 1 schematically illustrates the composition of the multilayer film (8).

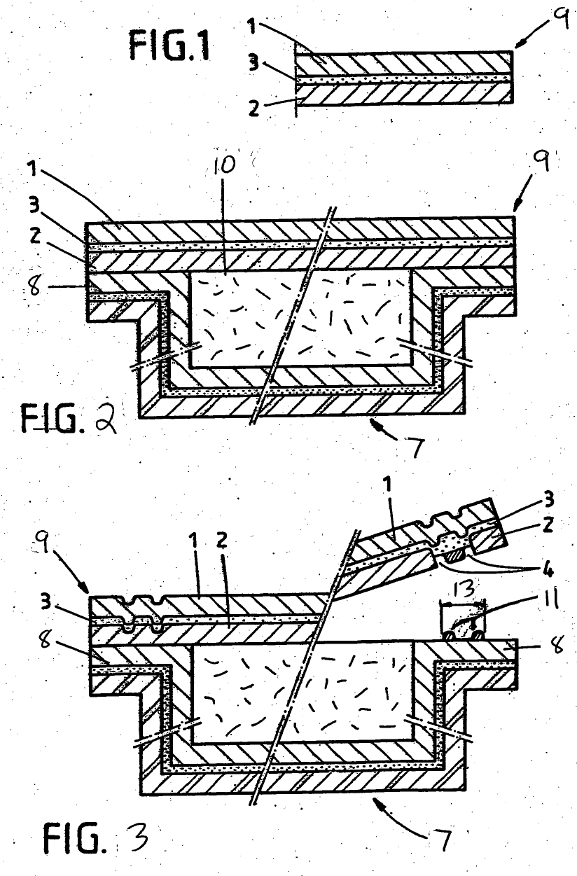

FIG. 2 is a schematic cross-section through the resealable container (7) according to the invention in its closed state.

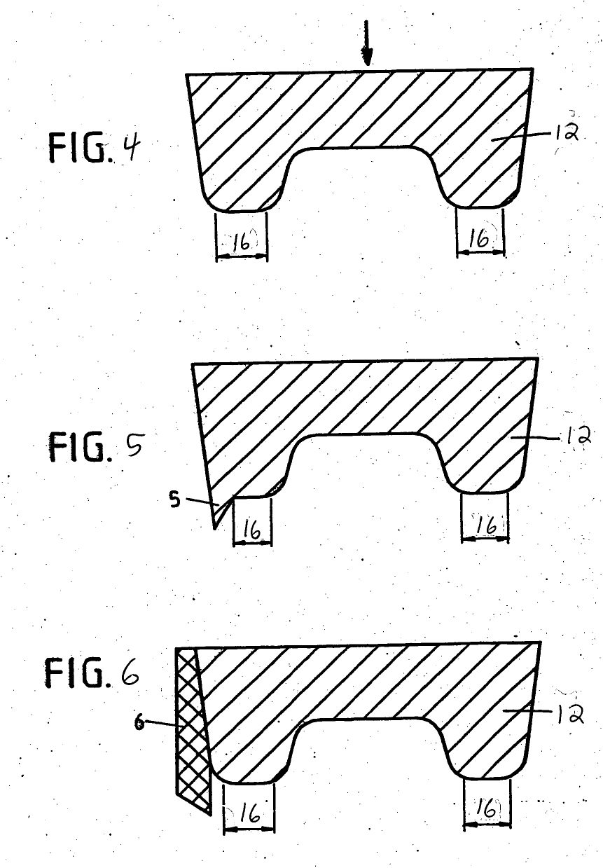

FIG. 3 is a schematic cross-section through the resealable container (7) after sealing in a partly opened state.

The multilayer film (9) may be a combination of any number of films. The multilayer film (9) has a thickness of about 23 to 200 micrometers, preferably in the range from 40 to 160 micrometers and more particularly in the range from 60 to 120 micrometers.

The outer layer (1) typically consists of polyethylene terephthalate, polyamide, biaxially oriented polypropylene, polyvinyl chloride or metal foils, for example aluminium, or paper. The outer layer (1) has a thickness of 20 to 150 micrometers, preferably in the range from 30 to 100 micrometers and more particularly in the range from 40 to 80 micrometers. The outer layer (1) is designed not to melt at temperatures of up to 200° C.

The side of the multilayer film which is used for sealing and which is called the sealing layer (2) generally consists of a polymeric material with low breaking elongation and tear propagation resistance. Polyolefins are preferably used as the polymeric material for the sealing layer (2). The polyolefins used for the sealing layer (2) include, for example, propylene copolymers, more particularly ethylene/propylene/butylene copolymers, ethylene/propylene/butylene terpolymers or mixtures of these polymers. Films suitable for the outer layer (1) and the sealing layer (2) and suitable materials for the rim (8) are described in EP 0868368 B1, DE 3935480 A1, U.S. Pat. No. 4,913,307, DE 3413352 C2 and U.S. Pat. No. 5,145,737.

In a preferred embodiment, the sealing layer (2) consists of high-density polyethylene. “High density polyethylenes” are polyethylenes which are substantially linear or branched. These polyethylenes have degrees of crystallization of 60 to 80% and a density of ca. 0.94 to 0.965 g/cm³.

The melting point of the polymeric material for the sealing layer (2) is generally in the range from 80 to 160° C. and preferably in the range from 100 to 140° C.

In one particular embodiment of the invention, one side of the film used as the sealing layer (2) is pretreated. The pretreated side is integrated into the composition of the film laminate; the non-pretreated side is used for sealing. Pretreatment in the context of the invention is understood to be a process by which the surface of plastics is modified in order to improve adhesion to other materials, for example paints or adhesives. Processes known to the expert include, for example, the corona process or flame application.

The sealing layer (2) may have a thickness of 1 to 80 micrometers, preferably in the range from 10 to 60 micrometers and more particularly in the range from 20 to 50 micrometers.

Known film combinations for multilayer films include, for example,

metallized PET/PE/adhesive layer/PE

PET-P/adhesive layer/PE

PET (36 micrometers)/adhesive layer/PE

PET (12-19 micrometers)/aluminium foil (7-9 micrometers)/PE (80-100 micrometers)/adhesive layer/PE (50 micrometers)

PET/adhesive layer/coex. PET/(coex. PET is, for example, PE/PET/PE)

PET/adhesive/polyolefin/heat-sealing lacquer.

In one particular embodiment of the invention, the sealing layer (2) contains a sealable layer of cold sealing adhesive or heat sealing adhesive. The sealable layer of cold sealing adhesive or heat sealing adhesive is applied to a polyolefin film which, itself, may also be a sealing layer (2). The cold sealing adhesive or heat sealing adhesive is applied to all or part of the surface of the polyolefin film. Partial application in the sealing zone is preferred. The cold sealing adhesive or heat sealing adhesive may be applied in a quantity of 2 to 10 g/m², preferably in a quantity of 3 to 8 g/m² and more particularly in a quantity of 4 to 6 g/m².

In one particular embodiment of the invention, the multilayer film (9) comprises at least

a) an outer layer (1) and

b) two sealing layers (2), the sealing layers being separated by an adhesive layer (3) which occupies 70 to 99% and preferably 85 to 95% of the surface area of a sealing layer.

The outer layer (1) preferably consists of polyethylene terephthalate.

In the region where the adhesive coating is partly recessed, permanent sealing between the sealing layers and the rim (8) is achieved by sealing. In a preferred embodiment of the invention, the multilayer film (9) is sealed against the rim (8) in such a way that 65 to 85% of the sealable periphery of (8) has a double bead and 35 to 15% is permanently sealed. In the case of a rectangular pack, for example, three sides are provided with a double bead and one side is permanently sealed. On the one hand, less adhesive is thus needed; on the other hand, the permanently sealed part acts as a hinge. The cover remains attached to the pack part so that faster and exact resealing is possible.

The multilayer film (9) is made by joining together the outer layer (1) and the sealing layer (2) with the adhesive layer (3). The process of joining films together with adhesive is known as lamination. Any suitable lamination process may be used to join films together, rolling or pressing of the films together being preferred. In the process known as calendering, the films are laminated with adhesive and passed in a certain path between calendering rollers under suitable roller pressures and at suitable roller temperatures and speeds, so that they acquire certain thickness, density or transparency values or even surface effects, such as for example gloss, smoothness or embossing.

In one particularly preferred process for the production of the multilayer film (9), the outer layer (1) and the sealing layer (2) are laminated with an adhesive which is applied through a slot die and passed between one or more pairs of rollers, the plastic films being laminated by the nip pressure of the pair(s) of rollers. The pair(s) of rollers is/are heated to a temperature of 30 to 160° C., preferably to a temperature of 40 to 150° C. and more particularly to a temperature of 50 to 130° C. The roller pressure, based on a roller width of 1,000 mm, is in the range from 1 to 8 bar, preferably in the range from 2 to 7 bar and more particularly in the range from 3 to 6 bar. The lamination speed is in the range from 10 to 200 m/s, preferably in the range from 50 to 150 m/s and more particularly in the range from 80 to 120 m/s.

In a particularly preferred embodiment, the adhesive is applied by curtain coating. For faster curing, the adhesive is preferably exposed to UV light or electron beams.

After the lamination step, the multilayer film (9) is sealed against the rim (8) of the container opening (10) by means of a sealing tool. The double-bead weak spot (11) may be produced by the sealing tool (12) according to the invention of which the preferred embodiment is described in detail in the following with reference to FIG. 4.

FIG. 4 is a schematic cross-section through the sealing tool (12) according to the invention.

The sealing tool (12) for making the resealable container (7) according to the invention is provided with partial sealing surfaces (16). The provision of the partial sealing surfaces (16) allows the embrittlement so that the weak spot (11) is in the form of a double bead over the width (13). The sealing tool (12) may assume various forms; for example, it may have a roof-like or horseshoe-like cross-section. In the preferred embodiment, the sealing tool (12) has a horseshoe-like cross-section. In all the selected embodiments, the basic geometry is such that—in cross-section—two sealing walls with the corresponding partial sealing surfaces are separated from one another by a space. Both the width of this space and the width of one or both sealing walls may vary according to the nature and requirement profile of the resealable container to be produced. The width of a sealing wall may be 1 to 16 mm, preferably 1.5 to 10 mm and more particularly 2 to 6 mm. The width of the space between the sealing walls may be 0.5 mm to 18 mm, preferably 1 mm to 10 mm and more particularly 1.5 to 5 mm.

Compared with known sealing tools which seal over the entire width (13), the design with partial sealing surfaces achieves a higher sealing pressure per unit area for the same applied pressure. As also stated in DE 0.34133352 C2, a reduced sealing surface leads to a smaller area of contact between the sealing tool (12), the multilayer film (9) and the rim (8) and, hence, possibly to an inadequate overall strength of the weld produced. To solve this problem, DE 3413352 C2 proposes sealing over the entire width (13) through the presence of at least one secondary welding zone adjoining the primary welding zone in which the cover and the bowl are not pressed as heavily against one another as in the primary welding zone. According to the present invention, adequate overall strength is achieved by the design of the sealing tool with two partial sealing surfaces. Not only greater strength, but also a better sealing effect is achieved through the parallel sealing beads (double bead).

In order to make residues of adhesive, for example, easier to remove, the sealing tool may be coated accordingly, for example with PTFE (polytetrafluoroethylene).

In one particular embodiment, the sealing layer (2) of the resealable container (7) has weak spots in the form of weakening lines. In this embodiment, the sealing layer (2) is scored, cut or perforated for example. The scoring, cutting or perforation of the sealing layer (2) is carried out during the production of the multilayer film or preferably during the sealing step, for example by means of a controlled laser beam.

In one particular embodiment, if the weak spots are produced during sealing by the sealing tool (12), a partial sealing surface of the sealing tool (12) according to the invention preferably comprises an edge (5) (FIG. 5).

In another particular embodiment, the sealing tool (12) comprises preferably one separately applied edge (6) on a partial sealing surface (16) which may optionally be replaced after a certain period of use (FIG. 6).

In another embodiment, the edge (5) machined out of the partial sealing surface may be replaced by toothed, serrated, wedge-shaped or wave-like projections. The depth of the edge (5), (6) or the toothed, serrated, wedge-shaped or wave-like projections is gauged so that it corresponds to the thickness of the outer layer (1). The edge (5), (6) or the toothed, serrated, wedge-shaped or wave-like projections weaken(s) the sealing edges at the sealing layer (2) and thus provides for selective scoring in the desired area. The weakening of the sealing edge (14) or sealing edges extends over the entire weak spot (11) or is preferably confined to that part (15) of the weak spot (11) or seal which lies in the vicinity of a conventional tear strip (FIG. 7). The edge (5), (6) or the toothed, serrated, wedge-shaped or wave-like projections is/are so conditioned that the outer layer (1) is not cut, perforated or otherwise damaged during the sealing process. By virtue of its resilience, the outer layer (1) shows little, if any, embossing produced by the sealing tool (12) according to the invention after the sealing process.

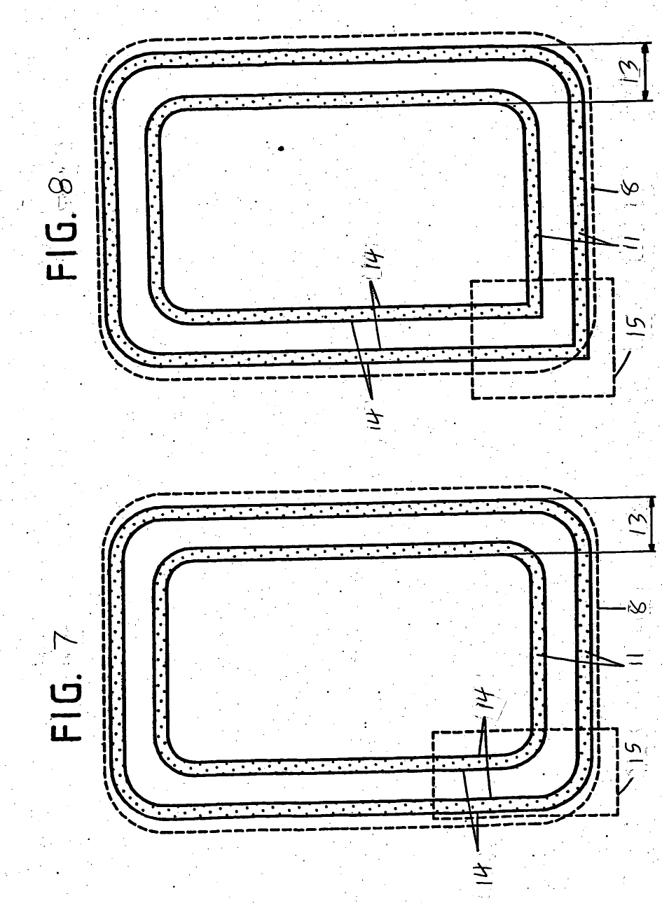

In another particular embodiment, the sealing tool (12) is shaped in such a way that the seal is angular rather than rounded in the vicinity of the tear strip (FIG. 8). The angular seal in the vicinity of the tear strip produces a pin-point contact surface which provides for controlled tearing.

FIG. 7 is a schematic plan view of the sealing zone with a schematized partial region in which one or all the sealing edges is/are weakened.

FIG. 8 is a schematic plan view of an angular seal.

For the case where, besides the double bead, a permanent seal is produced, at least one partial sealing surface is correspondingly modified in order to compensate for the lack of adhesive applied in the preferred thickness range of 15 to 25 μm.

The present invention also relates to a process for the production of a resealable container (7) with a rim (8) and a multilayer film (9) covering the container opening (10) and the rim (8) comprising a rim (8) and a multilayer film (9) covering the container opening (10) and the rim (8), the multilayer film (9) consisting at least of an outer layer (1), a sealing layer (2) facing the rim (8) and a layer (3) of adhesive between the outer layer (1) and the sealing layer (2) and the sealing layer (2) being secured around the rim (8) and being embrittled to form a weak spot (11) and the embrittlement being achieved by means of a sealing tool (12) and the weak spot (11) being in the form of a double bead over the width (13). In a preferred embodiment of the process, the sealing layer (2) comprises weak spots in the form of weakening lines produced, for example, by scoring, cutting or perforation during the production of the multilayer film or preferably during the sealing process.

The resealable container according to the invention is distinguished by extremely safe resealing, even at low temperatures and in the presence of moisture. The embodiment in the form of a double bead increases the stability of resealing and leads to a more accurate fit.

The resealable container according to the invention is suitable for the packaging of sensitive products, such as chocolate, coffee, savoury sticks, marzipan and the like. By virtue of its excellent resealing properties, the resealable container according to the invention is suitable for the packaging of, in particular, oxidation-sensitive foods and luxury foods.

To produce the multilayer film (9), the outer layer (1) and the sealing layer (2) are joined together by the adhesive layer (3).

The adhesive layer (3) has a thickness of 2 to 30 micrometers, preferably 5 to 20 micrometers and more particularly 8 to 15 micrometers. The adhesive is applied in a quantity of 1 to 30 g/m², preferably 3 to 25 g/m² and more particularly 5 to 20 g/m².

The adhesive layer (3) is formed by a pressure-sensitive adhesive which has a Brookfield viscosity at 150° C., as measured to ASTM D 3236-88, in the range from 5,000 to 30,000 mPa.s, preferably in the range from 8,000 to 25,000 mPa.s and more particularly in the range from 10,000 to 20,000 mPa.s.

Pressure-sensitive adhesives or PSAs for short are viscoelastic adhesives which, in solventless form, remain permanently tacky and ready for bonding at ca. 20° C. and which adhere immediately to almost all substrates (low substrate specificity) under light pressure. Pressure-sensitive adhesives are applied to the substrate—generally known as the carrier material—in the form of solutions in organic solvents, aqueous dispersions or even melts. Preferred organic solvents are aliphatic solvents, for example ethyl acetate or methyl ethyl ketone, optionally even hexane or heptane, or low-boiling hydrocarbon mixtures, for example petroleum ether. Pressure-sensitive adhesives suitable for use in accordance with the invention are described, for example, in WO 01/14491, WO 98/00471, US 2001/0044024 A1, U.S. Pat. No. 3,239,478 and U.S. Pat. No. 5,292,842.

Low-viscosity, solventless reactive systems (more particularly polyurethane systems) are also used as pressure-sensitive adhesives and are optionally exposed to UV light or electron beams for curing.

The raw materials used for pressure-sensitive adhesives are water-soluble and water-insoluble basic polymers, plasticizers, waxes, resins, more particularly tackifying resins for improving adhesion, fillers and auxiliaries, such as preservatives, antioxidants, stabilizers and dyes.

The basic polymers largely determine the cohesive properties, the strength and the temperature behavior of the pressure-sensitive adhesive. The basic polymers are present as component A in the pressure-sensitive adhesive in a concentration of generally 1 to 50% by weight and preferably 5 to 40% by weight.

A pressure-sensitive adhesive is generally made up of at least one basic polymer and at least one tackifying resin (so-called tackifier), the tackifying resin being replaceable in some systems by low molecular weight components of the basic polymer. In order to increase cohesion, the basic polymer in some systems is crosslinked or, in the case of rubber pressure-sensitive adhesives, is vulcanized after application.

Accordingly, suitable basic polymers for pressure-sensitive adhesives are natural and synthetic rubbers in conjunction with modified natural resins, phenol/formaldehyde resins or hydrocarbon resins. Besides rubber, polyacrylates, polymethacrylates, polyvinyl ethers and polyisobutenes are also commonly used, again mostly in combination with resins. Silicone resin pressure-sensitive adhesives are also known for special applications.

The dispersion-type pressure-sensitive adhesives are based mainly on polyacrylate dispersions and, in some cases, on special vinyl acetate copolymers; here, too, resins are mostly added.

Besides suitable resins, the following basic polymers are mainly used for pressure-sensitive hotmelt adhesives:

1) elastic polymers, such as block copolymers, for example styrene/butadiene, styrene/butadiene/styrene, styrene/isoprene/styrene, styrene/ethylene/butylene/styrene, styrene/ethylene/propylene/styrene;

2) ethylene/vinyl acetate polymers, other ethylene esters and copolymers, for example ethylene/methacrylate, ethylene/n-butyl acrylate and ethylene/acrylic acid;

3) polyolefins, such as polyethylene and polypropylene, more particularly amorphous propylene α-olefins (APAOs);

4) polyvinyl acetate (PVAc) and PVAc copolymers,

5) polyacrylates;

6) polyamides;

7) polyesters;

8) polyvinyl alcohols (PVA) and PVA copolymers;

9) polyurethanes;

10) polystyrenes;

11) polyepoxides;

12) copolymers of vinyl monomers and polyalkylene oxide polymers;

13) resin-containing aldehydes, such as phenol aldehyde, urea aldehyde, melamine aldehyde and the like.

The resin is intended to improve adhesion and to improve the compatibility of the pressure-sensitive adhesive components. It is used as component B in a quantity of generally 1 to 80% by weight and preferably 35 to 65% by weight. The resin may, for example, be selected from

a) hydroabietyl alcohol and esters thereof, more especially esters with aromatic carboxylic acids, such as terephthalic acid and phthalic acid, preferably modified natural resins, such as resinic acids of gum rosin, liquid rosin or wood rosin, for example fully saponified gum rosin or alkyl esters of optionally partly hydrogenated rosin with low softening points, for example methyl, diethylene glycol, glycerol and pentaerythritol esters,

c) acrylic acid copolymers, preferably styrene/acrylic acid copolymers, acrylate copolymers,

d) resins based on functional hydrocarbon resins; and

e) aliphatic, cycloaliphatic, aromatic, and alkylaromatic hydrocarbon resins.

An alkyl ester of partly hydrogenated rosin—the alkyl group preferably containing 1 to 6 carbon atoms—may also be used as the tackifying resin.

Polymerized liquid rosin, hydrogenated hydrocarbon resin and rosin glycerol ester are preferably used.

The wax is present as component C in the pressure-sensitive adhesive in a concentration of generally 0 to 40% by weight and preferably 5 to 40% by weight.

The wax used may be of natural, chemically modified or synthetic origin. Suitable natural waxes are vegetable waxes, animal waxes, mineral waxes or petrochemical waxes. Suitable chemically modified waxes are hard waxes, such as montanic ester waxes, sarsol waxes, etc. Suitable synthetic waxes are polyalkylene waxes and polyethylene glycol waxes. Preferred waxes are petrochemical waxes, such as petrolatum, paraffin waxes, microwaxes and synthetic waxes, more particularly polyethylene waxes with melting points of 85 to 140° C. and molecular weights in the range from 500 to 3,500, paraffin waxes with melting points of 45 to 70° C. and molecular weights of 225 to 500, microcrystalline waxes with melting points of 60 to 95° C. and synthetic Fischer-Tropsch waxes with melting points of 100 to 115° C.

The plasticizer may be present as component D in the pressure-sensitive adhesive in a concentration of generally 1 to 30% by weight and preferably 5 to 30% by weight. Suitable plasticizers are mono- and polyhydric alcohols, preferably glycol monophenyl ether, hexamethylene glycol, glycerol and, in particular, polyalkylene glycols with a molecular weight of 200 to 6,000. Polyethylene glycols with a molecular weight of up to about 1,000 and preferably up to about 600 are preferred. Polypropylene glycol, polybutylene glycol and polymethylene glycol are also suitable. Other suitable plasticizers are esters, for example liquid polyesters and glycerol esters, such as glycerol diacetate and glycerol triacetate, neopentyl glycol dibenzoate, glyceryl tribenzoate, pentaerythritol tetrabenzoate and 1,4-cyclohexane dimethanol dibenzoate. Finally, alkylmonoamines and fatty acids preferably containing 8 to 36 carbon atoms may also be used. Plasticizers based on aromatic dicarboxylic acid esters, i.e. the corresponding esters of phthalic acid, isophthalic acid or terephthalic acid, are preferably used. The alcohol component of these esters used as plasticizers normally contains 1 to 8 carbon atoms. Medicinal white spirit and naphthenic mineral oil above all are suitable plasticizers.

Although the fillers—component E—may be used in concentrations of 0 to 30% by weight to reduce the cost of the pressure-sensitive adhesive, they are preferably intended to improve the performance, adhesive and optionally working-up properties. The fillers used are solid, non-volatile inert materials, above all chalk.

In addition, typical auxiliaries and additives may be incorporated in the pressure-sensitive adhesive as component F. Stabilizers are mentioned first and foremost in this regard. Their function is to prevent the reactive monomers from entering into an unwanted or premature reaction and to protect the polymers against decomposition during processing. Such stabilizers are, in particular, antioxidants. They are added to the pressure-sensitive adhesive in quantities of typically up to 3% by weight and preferably about 0.1 to 1.0% by weight. Other auxiliaries and additives are pigments, more particularly TiO₂.

The composition suitable for use as a pressure-sensitive adhesive in accordance with the invention generally contains the following components:

A) 1 to 50 and preferably 5 to 40% by weight of at least one basic polymer from the group of ethylene and/or styrene copolymers;

B) 1 to 80 and preferably 35 to 65% by weight of at least one resin from the group of aliphatic, cycloaliphatic or aromatic hydrocarbon resins;

D) 1 to 30 and preferably 5 to 30% by weight of at least one plasticizer from the group of medicinal white spirits or naphthenic mineral oils;

F) 0 to 3 and preferably 0.1 to 1.0% by weight of at least one stabilizer, antioxidant or other auxiliaries;

the sum of the components being 100% by weight.

Pressure-sensitive adhesives with a Brookfield viscosity of 5,000 to 30,000 mPa.s, preferably 8,000 to 25,000 mPa.s and more particularly 10,000 to 20,000 mPa.s, as measured at 150° C. to ASTM D 3236 88, are preferably used for high-speed laminators. Such laminators operate at speeds of 80 to 150 m/s.

Radiation-crosslinkable pressure-sensitive adhesives are, in particular, hotmelt pressure-sensitive adhesives which contain the following components:

A) 1 to 40% by weight of at least one basic polymer from the group of styrene block copolymers, more particularly styrene/butadiene, styrene/butadiene/styrene, styrene/isoprene/styrene, styrenelethylene/butylene/styrene, styrene/ethylene/propylene/styrene block copolymers;

B) 35 to 90% by weight of at least one resin from the group of hydrocarbon resins, rosin glycerol esters and/or acrylate copolymers;

C) 0 to 40 and preferably 5 to 40% by weight of at least one wax from the group of microwaxes;

D) 0 to 30% by weight of at least one plasticizer from the group of medicinal white spirits;

E) 0 to 30% by weight of at least one filler; and

F) 0 to 3 and preferably 0.1 to 1.0% by weight of at least one stabilizer, photoinitiator, antioxidant or other auxiliaries;

the sum of the components being 100% by weight.

In the context of the present invention, the “radiation-crosslinkable” feature is understood to be the initiation of a polymerization reaction under the influence of radiation (photopolymerization). By radiation is meant any form of radiation which produces irreversible crosslinking in the crosslinkable pressure-sensitive hotmelt adhesive layer to be exposed to radiation. UV light, electron beams, short-wave visible light and even IR radiation are particularly suitable. In the case of EB or UV irradiation, the desired product properties are established through the radiation dose and, in the case of IR radiation, through the product temperature and the residence time.

An overview of the prior art on the radiation crosslinking of pressure-sensitive hotmelt adhesives is presented, for example, by R. Jordan under the title “Schmelzhaftklebstoffe”, Vol. 6b from the series “Kiebstoff-Monographien” published by Hinderwaldner-Verlag, 1989, pages 126 to 155 and in the article entitled “UV-vernetzbare Acrylat-Schmelzhaftklebstoffe” by Auchter, Barwich, Rehmer and Jager in “kleben&dichten” 37 (1993), pages 14 to 20.

Radiation crosslinking by UV light or electron beams is preferred for the purposes of the present invention. The exposure of the pressure-sensitive hotmelt adhesive according to the invention to UV light takes place at a wave length of 100 to 380 nm. The UV rays are generally produced in gas discharge lamps of which mercury vapor lamps in particular may be used as medium- and high-pressure lamps (1 to 10 bar). A UV dose of 50 to 2,000 J/cm² may be applied. Where the pressure-sensitive hotmelt adhesive according to the invention is exposed to electron beams, a radiation dose of 10 to 100 kilogray (kGy) is preferred. If the pressure-sensitive hotmelt adhesive according to the invention is exposed to UV light, crosslinking is controlled not only by the particular radiation dose, but also by the use of photoinitiators, photosensitizers or controller molecules (component F), component (F) being present in the formulation in a quantity of 0.1 to 3% by weight, based on the composition as a whole. The pressure-sensitive hotmelt adhesives to be used in accordance with the invention are generally prepared by mixing

1. plasticizers, waxes and resins at 120 to 180° C., more particularly at 160° C., to form a homogeneous melt,

2. optionally fillers, auxiliaries and finally the basic polymers with stirring to homogeneity,

preferably in an inert gas atmosphere and/or in vacuo.

After the fully homogenized composition has been packed in suitable containers, it is left to cool in those containers, solidifying in the process. It is now ready for use. The melt could of course also be applied to a substrate directly, i.e. without cooling, and thus directly used for bonding.

The pressure-sensitive adhesives used in accordance with the invention give transparent and—depending on application rate of the adhesive—virtually streak-free adhesive layers (3). By transparent is meant more or less clear to glass-clear. The pressure-sensitive adhesives used in accordance with the invention are distinguished by a neutral odor and little, if any, color. They are acceptable for indirect contact with foods. The pressure-sensitive adhesives used in accordance with the invention are particularly suitable for curtain coating because the adhesive film does not break up as it falls. The pressure-sensitive adhesive to be used in accordance with the invention is further distinguished by excellent heat stability. Accordingly, it is particularly suitable for the use of resealable packs of which the contents have to be sterilized. The pressure-sensitive adhesive is suitable for all known multilayer films and has excellent resealability, particularly at low temperatures and in the presence of moisture. The pressure-sensitive adhesive to be used in accordance with the invention is also suitable for laminators designed for the use of solvent-based laminating adhesives. To this end, the pressure-sensitive adhesive used in accordance with the invention is dissolved in ethyl acetate or MEK, optionally even in hexane or heptane or low-boiling hydrocarbon mixtures, for example petroleum ether.

The invention is described in more detail in the following.

Description of the Measuring Methods

Determination of viscosity (Brookfield, model RVT DV II, 150° C.) to ASTM D 3236 88

Stringing

A glass rod is introduced into the hotmelt adhesive melted at ca. 160° C. and slowly withdrawn and the Theological behavior of the hotmelt adhesive is visually evaluated. Evaluation includes the manner in which the molten adhesive drips off the glass rod and the formation of adhesive threads during withdrawal of the glass rod from the adhesive melt.

### EXAMPLES

I. Adhesive Tests

In a pilot plant (manufacturer: Bilihöfer), the commercially obtainable pressure-sensitive adhesives LIOTRON PS 4110 (acrylate-based hotmelt adhesive, Brookfield viscosity 5,000-15,000 m.Pas at 140° C.) and TECHNOMELT Q 8707 (pressure-sensitive hotmelt adhesive based on synthetic rubber and hydrocarbon resin, Brookfield viscosity 22,000 to 28,000 m.Pas at 150° C.) of Henkel KGaA were applied by curtain coating through a slot die (manufacturer: Inatek) to produce a multilayer film consisting of PET/adhesive/PE. In every case, the application rate was 20 g/m². LIOTRON PS 4110 was applied at a temperature of 50° C. and a machine speed of 10 m/s. The laminating pressure was 200-300 kg. The adhesive was additionally exposed to a UV-C lamp (500 mm wide, 200 watt/cm max., 20 amps., 87.5% output). TECHNOMELT Q 8707 was applied at a rate of 20 g/m² at a temperature of 120° C. and at a machine speed of 10 m/s. The laminating temperature was 60° C., the laminating pressure 200-300 kg. In a second test, TECHNOMELT Q 8707-23 was applied at a rate of 10 g/m² at 130° C. and at a machine speed of 20 m/s. The laminating pressure was again 200-300 kg. In another test, TECHNOMELT Q 8707-23 was used to produce a multilayer film laminate of PET/Alu/PE/adhesive/PE.

Results

The multilayer films produced in (I.) are distinguished by typical laminate adhesion and sealing seam adhesion values. Resealing was still good after closing more than 20 times.

Table 1: results for 2-ply laminate (PET/adhesive/PE)

Table 2: results for 4-ply laminate (PE/Alu/PE/adhesive/PE)

The values reported in Tables 1 and 2 are seal strength (units N/15 mm).

“MW” is the median value out of 5 measurements (n=5).

TABLE 1

| | |
|---|---|
| (n = 5) | Q 8707-23 |

| | | |
|---|---|---|
| 160° C. | Min | 0.1 |
| | Max | 0.1 |
| | MW | 0.1 |
| 170° C. | Min | 0.2 |
| | Max | 0.5 |
| | MW | 0.4 |
| 180° C. | Min | 2.2 |
| | Max | 2.7 |
| | MW | 2.5 |
| 190° C. | Min | 3.3 |
| | Max | 6.2 |
| | MW | 4.8 |
| 200° C. | Min | 5.6 |
| | Max | 13.1 |
| | MW | 7.9 |

TABLE 2

| | | Q 8707-23 | Q 8708-23 |
|---|---|---|---|
| | | Non-pretreated | Pretreated |
| | | PE side | PE side |
| 190° C. | Min | 0.3 | 0.3 |
| | Max | 0.5 | 0.1 |
| | MW | 0.4 | 0.7 |
| 200° C. | Min | 1.4 | 1.4 |
| | Max | 2.7 | 3.7 |
| | MW | 2.1 | 2.4 |
| 210° C. | Min | 2.0 | 5.0 |
| | Max | 4.1 | 7.2 |
| | MW | 3.3 | 6.4 |
| 220° C. | Min | 3.9 | 5.1 |
| | Max | 10.8 | 10.3 |
| | MW | 6.5 | 6.5 |
| 230° C. | Min | 2.3 | 3.5 |
| | Max | 12.8 | 5.6 |
| | MW | 7.4 | 4.9 |
| 240° C. | Min | 1.8 | 4.0 |
| | Max | 7.9 | 4.9 |
| | MW | 4.6 | 4.5 |

In Table 2:
“Q 8707-23/non-pretreated PE side” means that the adhesive is applied to the non-pretreated side of the polyethylene used as the sealing layer (2). The pretreated side of the polyethylene sealing layer is used for sealing.
“Q 8707-23/pretreated PE side” means that the adhesive is applied to the pretreated side of the polyethylene used as the sealing layer (2). The untreated side of the polyethylene sealing layer is used for sealing.

### LIST OF REFERENCE NUMERALS

1=outer layer

2=sealing layer

3=adhesive layer

4=adhesive layer exposed after tearing

5=edge on sealing surface

6=separately applied edge

7=container

8=rim

9=multilayer film

10=container opening

11=weak spot

12=sealing tool

13=width of double bead

14=sealing edge(s)=

15=partial sealing zone

What is claimed is:

1. A resealable container having a container opening, said resealable container comprising a rim and a multilayer film covering the container opening and the rim, the multilayer film comprising at least an outer layer, a sealing layer facing the rim and a layer of adhesive between the outer layer and the sealing layer and the sealing layer being secured around the rim and containing a weak spot such that when the resealable container is first opened a double bead of said sealing layer remains on the rim in the region of the weak spot.

2. A resealable container as claimed in claim 1, wherein the outer layer comprises at least one material selected from the group consisting of polyethylene terephthalate, polyamide, biaxially oriented polypropylene, polyvinyl chloride, metal foil, and paper.

3. A resealable container as claimed in claim 1, wherein the sealing layer is comprised of at least one polyolefin selected from the group consisting of propylene copolymers and high-density polyethylene.

4. A resealable container as claimed in claim 1, wherein the sealing layer is comprised of a polymeric material having a melting point of 80 to 160° C.

5. A resealable container as claimed in claim 1, wherein the sealing layer comprises weak spots in the form of weakening lines.

6. A resealable container as claimed in claim 1, wherein the multilayer film comprises at least:
a) an outer layer; and
b) two sealing layers, the sealing layers being separated by an adhesive layer which occupies 70 to 99% of the surface area of a sealing layer.

7. A resealable container as claimed in claim 6, wherein the multilayer film is sealed against the rim in such a way that 65 to 85% of the sealable periphery of the rim has a double bead and 35 to 15% of the sealable periphery of the rim is permanently sealed.

8. A resealable container as claimed in claim 1, wherein the sealing layer comprises a sealable layer of cold sealing adhesive or heat sealing adhesive.

9. A resealable container as claimed in claim 1, wherein the layer of adhesive has a thickness of 2 to 30 micrometers.

10. A resealable container as claimed in claim 1, wherein the layer of adhesive comprises a pressure-sensitive adhesive with a Brookfield viscosity at 150° C., as measured by ASTM D 3236 88, in the range from 5,000 m.Pas to 30,000 m.Pas.

11. A resealable container as claimed in claim 1, wherein the layer of adhesive comprises:
A) 1 to 50% by weight of at least one basic polymer selected from the group consisting of ethylene copolymers and styrene copolymers;
B) 1 to 80% by weight of at least one resin selected from the group consisting of aliphatic, cycloaliphatic and aromatic hydrocarbon resins;
D) 1 to 30% by weight of at least one plasticizer selected from the group consisting of medicinal white spirits and naphthenic mineral oils; and
F) 0 to 3% by weight of at least one auxiliary;
the sum of the components being 100% by weight.

12. A resealable container as claimed in claim 1, wherein the layer of adhesive comprises a radiation-crosslinked adhesive.

13. A resealable container as claimed in claim 1, wherein the sealing layer is embrittled in the region of the weak spot.

14. A resealable container as claimed in claim 1, wherein said weak spot is formed using a sealing tool comprising two sealing walls separated from one another by a space and each sealing wall has a width of 1 to 16 mm.

15. A resealable container as claimed in claim 1, wherein said weak spot is formed using a sealing tool comprising two sealing walls separated from one another by a space and each sealing wall has a width of 2 to 6 mm.

16. A resealable container as claimed in claim 1, wherein said weak spot is formed using a sealing tool comprising two sealing walls separated from one another by a space having a width of 0.5 to 18 mm.

17. A resealable container as claimed in claim 1, wherein said weak spot is formed using a sealing tool comprising two sealing walls separated from one another by a space having a width of 1.5 to 5 mm.

18. A process for producing the resealable container claimed in claim 1, said process comprising sealing the multilayer film against the rim using a sealing tool comprising two sealing walls separated from one another by a space.

19. A process as claimed in claim 18, wherein the sealing layer is embrittled in the region of the weak spot.

20. The resealable container claimed in claim 1 in combination with a food product packaged therein.
